(19) United States
(12) Patent Application Publication
(10) Pub. No.: US 2026/0247456 A1
(43) Pub. Date: Aug. 20, 2026

(54) PRIVACY-PRESERVING SECURE DEVICE AND ACCESSORY CONNECTION AND COMMUNICATION FOR FIRST PARTY AND THIRD-PARTY APPLICATIONS

(71) Applicant: Apple Inc., Cupertino, CA (US)

(72) Inventors: Siva Ganesh Movva, San Jose, CA (US); Chen Ganir, San Jose, CA (US); Michael C. Laster, Santa Clara, CA (US); Emmanuel Lalande, Montreal (CA); Kerry Nguyen, Huntington Beach, CA (US)

(73) Assignee: Apple Inc., Cupertino, CA (US)

(21) Appl. No.: 19/546,075

(22) Filed: Feb. 20, 2026

Related U.S. Application Data
(60) Provisional application No. 63/761,079, filed on Feb. 20, 2025.

(51) Int. Cl. H04W 76/10; H04W 12/03; H04W 12/041

(52) U.S. Cl. CPC H04W 76/10; H04W 12/03; H04W 12/041

(57) ABSTRACT

Techniques may include detecting a trigger for establishing a communication pathway with an accessory device from an application that is associated with the accessory device. The trigger may include an accessory identifier. In addition, the techniques may include accessing a mapping of accessory identifiers to sets of cryptographic information, and the techniques may include identifying a set of cryptographic information that corresponds to the accessory device based on a mapping of accessory identifiers to sets of cryptographic information. Moreover, the techniques may include accessing an advertising message that corresponds to the set of cryptographic information. Also, the techniques may include establishing the communication pathway between the mobile device and the accessory device using information that is associated with the advertising message. Further, the techniques may include permitting communication between the application and the accessory device via the communication pathway.

### CROSS-REFERENCES TO OTHER APPLICATIONS

This application claims the benefit of U.S. Provisional Application No. 63/761,079, for “PRIVACY-PRESERVING SECURE DEVICE AND ACCESSORY CONNECTION AND COMMUNICATION FOR FIRST PARTY AND THIRD-PARTY APPLICATIONS” filed on Feb. 20, 2025, which is herein incorporated by reference in its entirety for all purposes.

### BACKGROUND

A third-party accessory device may pair with a mobile device to allow certain functionality. In this case, the accessory may broadcast application advertisements that allow the application to detect and communicate with the accessory. Advertising messages may also be used for device tracking. An accessory may broadcast tracking advertisements that include cryptographic information that can be used to identify the accessory. A device or service that is associated with the accessory can use the cryptographic information to recognize the accessory, but an unrelated device should not be able to gather any identifying information from the advertising messages. Currently, the application advertising messages and the tracking advertising messages are separate messages. The current configuration protects privacy but results in an unnecessary battery drain because the accessories are broadcasting duplicative messages.

### BRIEF SUMMARY

Techniques may include detecting a trigger for establishing a communication pathway with an accessory device from an application that is associated with the accessory device. The trigger may include an accessory identifier. In addition, the techniques may include accessing a mapping of accessory identifiers to sets of cryptographic information, and the techniques may include identifying a set of cryptographic information that corresponds to the accessory device based on a mapping of accessory identifiers to sets of cryptographic information. Moreover, the techniques may include accessing an advertising message that corresponds to the set of cryptographic information. Also, the techniques may include establishing the communication pathway between the mobile device and the accessory device using information that is associated with the advertising message. Further, the techniques may include permitting communication between the application and the accessory device via the communication pathway.

The techniques may include a computer-readable medium storing a plurality of instructions that, when executed by one or more processors of a computing device, cause the one or more processors to perform operations of any of the techniques. The techniques may include a computing device with one or more non-transitory memories and one or more processors in communication with the one or more memories and configured to execute instructions stored in the one or more memories to perform operations of any of the techniques. The techniques may include corresponding methods, systems, hardware, devices, computer program products, or non-transitory computer readable media to perform any of the techniques.

### BRIEF DESCRIPTION OF THE DRAWINGS

FIG. 1 is a flowchart of process for transmitting advertising messages from an accessory device according to at least one embodiment.

FIG. 2 is a system architecture for privacy protecting device communication according to at least one embodiment.

FIG. 3 is a simplified sequence diagram for privacy protecting device communication according to at least one embodiment.

FIG. 4 is a flow chart of process for privacy protecting device communication according to at least one embodiment.

FIG. 5 is a block diagram of an example electronic device according to at least one embodiment.

FIG. 6 is a block diagram of an example mobile device according to at least one embodiment.

FIG. 7 shows a diagram of an example computer system according to an embodiment of the present disclosure.

FIGS. 8A-8F show simplified diagrams of application programming interfaces for privacy protecting device communication according to at least one embodiment.

### DETAILED DESCRIPTION

A single advertising message can be used for tracking and application functionality. A system process on a mobile device can include a mapping of device identifiers to cryptographic information, and an application can provide a device identifier to the system process with a request to connect to the accessory. The system process can use the cryptographic information to process advertising messages that are received by the mobile device, and the process can establish a communication pathway with the accessory when an advertising message from the accessory is identified using the device identifiers.

A crowdsourced location tracking system can use electronic devices for device tracking. Each device in the crowdsourced location tracking system can search for advertising messages of tracked devices. When an advertising message is located, the devices in the crowdsourced location tracking system can report the location to a server that can notify the tracked device's owner about their device's location. The advertising messages can include cryptographic information that can be used to determine the device's owner without exposing the owner's identity.

The mobile device can use a mapping of the cryptographic information to tracked device identifiers to enable this tracking functionality. The system process can expose an application programming interface that can enable a third-party application to receive information about detected devices without exposing the cryptographic information to the third-party manufacturer. The system process can enable a third-party application to use the tracking advertising messages to establish a communication pathway between the third party application and the accessory device. The accessory can use an established communication pathway to control the accessory device or otherwise communicate with the accessory. The system process can enable secure communication between the third party application and the accessory device without exposing potentially identifiable information to the third party manufacturer.

### I. Privacy Protecting Device Discovery

An accessory device can enable tracking functionality by reporting the accessory device's location to other electronic devices through advertising messages. This tracking functionality can allow someone to locate a lost bike or misplaced headphones. These advertising messages can be anonymized using cryptographic information, and, for example, the advertising messages can identify the electronic device to a paired mobile device using cryptographic information that is derived from a device identifier such as a hardware address (e.g., a Media Access Control (MAC) address). These derived device identifiers can be generated from the accessory device's assigned device identifier using a key derivation function. The accessory can provide an assigned device identifier to the mobile device during pairing, and the mobile device can use the key derivation function to generate derived device identifiers. The mobile device can recognize an advertising message from a paired accessory by matching a received derived device identifier and a locally generated derived device identifier. In some embodiments, the mobile device may not locally generate derived device identifiers, and, instead, the mobile device may access derived device identifiers from memory or a server.

The accessory device can allow for other functionality if the accessory is paired with another electronic device. Two electronic devices can be paired if the devices are associated so that the devices can establish and use a communication pathway over a personal area network. For example, headphones can communicate with an application on a paired mobile device to configure audio settings and stream music.

Pairing two devices can include exchanging identifying information. The paired mobile device can discover, and establish a communication pathway, by recognizing advertising messages that are broadcast by the accessory. The advertising message can be an invitation to establish a connection with the accessory device, and the paired mobile device can send a connection request in response to the advertising message. A system process of the mobile device can recognize advertising messages from a paired accessory device using the identifying information that was exchanged during pairing. This identifying information can include an assigned device identifier and a protocol identifier.

An advertising message can be used for both tracking functionality and establishing a communication pathway with a paired device. The mobile device may need to recognize an advertising message from the accessory in order to request a connection from the correct device. For example, an application on a mobile device may request a communication pathway to an accessory device after a user launches the application. This request can be provided to a system process that executes on the mobile device, and the system process can use cryptographic information to identify advertising messages for the requested accessory. The system process can use information in the advertising message to send a connection request to the accessory to allow communication between the application and accessory. For example, the advertising message may indicate a communication channel and a schedule that can be used to establish a communication channel with the accessory device. The schedule can include a communication window (e.g., a range of time) and a communication time period (e.g., a time duration) during which the communication channel can be established.

Techniques that enable an advertising message can be used for both tracking functionality and establishing a communication pathway with a paired device can improve the battery life of the accessory device. The accessory device can provide both tracking functionality and establishing a connection pathway while broadcasting half as many advertising messages as would be required for separate messages. Sending fewer advertising messages can improve the battery life of the accessory device. In addition, the battery life of the mobile device can be improved because fewer advertising messages are processed by the mobile device.

These techniques can reduce the risk that identifiable information about the accessory device's owner is exposed to third parties. For example, the cryptographic information is processed by a system process of the mobile device, and, therefore, the cryptographic information is not exposed to a third-party manufacturer of the accessory device. These techniques can improve battery life for both the mobile device and the accessory device while improving the devices' information security.

### A. Payload From Accessory Device

The payload for advertising messages can contain a protocol identifier and an advertised device identifier. The mobile device's system process can use the protocol identifier to obtain a set of derived device identifiers for paired devices that can be compared to the derived device identifier from the advertising message (e.g., the advertised device identifier). The payload can contain other identifiers in various embodiments. The system process may determine that the accessory device is not paired with the mobile device if the comparison does not find any matching derived device identifiers.

### 1. Data in Payload

A mobile device can use the payload for an accessory's advertising message to determine whether the accessory device that sent the message is paired with the mobile device (e.g., a paired device). This payload can include a cryptographically derived device identifier, such as a derived device identifier, that is calculated from the accessory device's assigned device identifier using cryptographic techniques. The derived device identifier can rotate (e.g., change) at regular intervals so that the advertising messages cannot be used to recognize the accessory without the appropriate cryptographic information.

The advertising message payload can be between twelve and thirty-seven bytes long. For example, bytes 0-5 can include the derived device identifier. In some embodiments, bytes 6-8 can optionally be reserved for flags that a device identifier can use to implement tracking functionality (e.g., to track the location of the accessory device). Bytes 9-12 are reserved for service data type-length-value information for the payload. Byte 13 represents a protocol identifier, and the protocol identifier can be a unique identifier for a particular manufacturer or manufacturer product line (e.g., the particular manufacturer can have multiple product lines). In some embodiments, the protocol identifier can be two or more separate identifiers (e.g., a manufacturer identifier and a product line identifier). The protocol identifier value can be assigned in coordination among manufacturers to ensure that a protocol identifier is unique to a particular manufacturer or manufacturer product line. The mobile device can store a table to cross reference a particular product identifier with a particular manufacturer or manufacturer product line. The product identifier can be provided to a system process by the mobile device and the process can use the product identifier to identify one or more corresponding derived device identifiers or a corresponding key derivation function. Byte 14 can be a state flag that indicates whether the accessory device has determined that the device is in a near state or a far state (e.g., the accessory device is within communication range of a paired mobile device in a near state). Bytes 15-36 can include payload data for the manufacturer, and, for example, the manufacturer payload data can include information that is used to implement tracking functionality.

The derived device identifier in advertising messages from an accessory device (e.g., the advertised device identifier) can change at different intervals. For instance, the advertised device identifier can change after every message, after a fixed number of messages, or after a time period. The changes to the advertised device identifier may be event based, and, for example, the accessory device can rotate the advertised device identifier when an accessory device accelerometer detects movement, or when the accessory device receives one or more reply messages sent in response to the advertising message.

The accessory device can select the advertised device identifier from a precalculated list of derived device identifiers, or the device can calculate the advertised device identifier using an assigned device identifier. In some embodiments, the derived device identifier can be calculated from the accessory device's hardware address or serial number using cryptographic techniques such as a key derivation function. A key derivation function can be a cryptographic algorithm that can calculate one or more derived device identifiers from a given device identifier (e.g., private key). The accessory device may provide the assigned device identifier, and timing information, as input to a particular derivation function (e.g., a key derivation function), and the particular key derivation function can output a derived device identifier. The assigned device identifier can be a hardware address, serial number or other identifier that is assigned to an accessory by the device's manufacturer during the device's assembly.

A key derivation function is a cryptographic algorithm that can be used to generate a derived device identifier from a secret value using a pseudorandom function. The secret value can be a private key, and the private key can be a primary device identifier for the accessory device. Key derivation functions can be used to stretch the private key into a longer key or to obtain keys of a required format. For example, the key derivation function can convert a group element that is the result of a Diffie-Hellman key exchange into a symmetric key that can be used with advanced encryption standard (AES). The pseudo random function can be a keyed cryptographic hash function such as secure hash algorithm 1 or secure hash algorithm 2.

A derived device identifier, or a key derivation function used to generate the derived device identifier, can be associated with a protocol identifier. The accessory device can include the derived device identifier, and a protocol identifier associated with the particular key derivation function, in an advertising message payload. It may be difficult or impossible to determine the primary device identifier from a derived device identifier without the key derivation function.

### 2. Flowchart

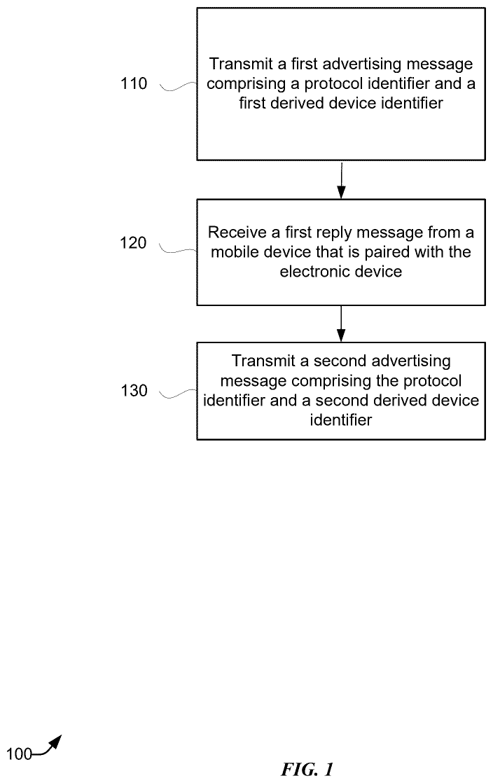

FIG. 1 is a flowchart of process 100 for transmitting advertising messages from an accessory device according to at least one embodiment. In some implementations, one or more process blocks of FIG. 1 can be performed by an accessory device such as devices 500-700. In some implementations, one or more process blocks of FIG. 1 can be performed by another device or a group of devices separate from or including the accessory device.

At block 110, a first advertising message comprising a protocol identifier and an advertised device identifier (e.g., a first derived device identifier) is transmitted by the accessory device. The protocol identifier specifies a derivation function that is used to generate the first derived device identifier using a private key and first timing information. The timing information can be transmitted in an advertising message and the timing information can comprise a local time on an internal clock of the accessory device. The private key can be an assigned device identifier such as a static hardware address associated with the accessory device (e.g., a hardware address that was assigned to the accessory device by the device manufacturer). However, any other identifier or code that is assigned by the manufacturer can be used as the primary device identifier.

After the message is received by a mobile device, the protocol identifier can be used by a system process of the mobile device to retrieve or generate a set of derived device identifiers from primary device identifiers for paired accessory devices (e.g., paired device identifiers). The protocol identifier can be provided to the system process, through an interface, and the system process can use the protocol identifier to access one or more pre-calculated derived device identifiers for paired devices (e.g., paired device identifiers). In addition, or alternatively, the system process can access a key derivation function using the protocol identifier and the mobile device can use the key derivation function to generate one or more derived device identifiers from the primary device identifiers for paired devices. For example, timing information and a private key (e.g., an assigned device identifier) for each paired device can be provided by the system process as input to a derivation function that is associated with the protocol identifier, and the set of derived device identifiers can be output by the key derivation function.

The private keys can be provided to the system process during a pairing procedure. For example, the system process may access an assigned device identifier from the accessory during the pairing procedure. In some embodiments, the accessory can retrieve the private key from the accessory during pairing, and the accessory may register the private key with the system process. The mobile device may store primary device identifiers for some or all of the devices that have been paired with the mobile device, and the device can provide these assigned device identifiers as input to the key derivation function identified by the protocol identifier to generate a set of derived device identifiers (e.g., a set of paired device identifiers). The set of paired device identifiers can be compared against the assigned device identifier to determine if the assigned device identifier matches any of the set of paired device identifiers. In response to detecting matching derived device identifiers, the system process may notify an application for an accessory device if an advertising message is received from the accessory.

At block 120, a first reply is received from a mobile device that has been paired with the accessory device. A paired accessory device can be a device that has previously exchanged identifying information with the mobile device, and a paired device may not be actively communicating with the mobile device over a communication pathway. The reply message can be transmitted in response to the mobile device receiving the advertising message from 110. The mobile device may transmit the reply message in response to matching the first derived device identifier from 110 and a derived device identifier obtained by the mobile device (e.g., a paired device identifier). The reply message can be a connection request message that can be used to establish a communication pathway, and an application may instruct the system process may send the connection request message.

At block 130, a second advertising message comprising the protocol identifier and a second derived device identifier is transmitted. The second derived device identifier (e.g., a second advertised device identifier) is generated by the derivation function from 110 using the private key from 110 and second timing information. In some embodiments, the timing information may change at regular intervals and two or more advertising messages may be transmitted with the first timing information and the first derived device identifier. For example, the timing information from 71:00:00 am-71:14:59 may be 71:00 am, and the timing information from 71:15:00 am-71:29:59 am can be 71:15 am. The intervals can be regular intervals or variable intervals in different embodiments.

The system process may identify the accessory that transmitted the second advertising message as a paired device using the second derived device identifier and a corresponding paired device identifier. The system process can notify an application that is associated with the accessory, and the application or system process can record information from the second advertising message. The application may have established a communication pathway using the first advertising message, and the application can use the information from second message to reestablish a connection if the communication pathway is interrupted. The application can reestablish a connection by instructing the system process to send a second connection request message.

Although FIG. 1 shows example steps of process 100, in some implementations, process 100 can include additional steps, fewer steps, different steps, or differently arranged steps than those depicted in FIG. 1. Additionally, or alternatively, two or more of the steps of process 100 can be performed in parallel.

### B. Matching on Mobile Device

A mobile device receiving the advertising message can retrieve, or calculate, a derived device identifier for accessory devices that are paired with the mobile device (e.g., a paired device identifier). For example, a system process on the mobile device can use an assigned device identifier for each paired accessory device, and the timing information from the advertising message, as input to the derivation function. In response, the key derivation function in the system process can output one or more derived device identifiers for each paired accessory device (e.g., a set of paired device identifiers). The accessory device that sent the advertising message can be identified by matching the derived device identifier from the advertising message with a derived device identifier that was generated by the mobile device.

In addition or alternatively, the mobile device's system process may use the protocol identifier and timing information from the advertising message to retrieve or generate one or more paired device identifiers. The paired device identifiers may be generated or accessed in response to an event such as launching an application that is associated with a paired accessory, or a request to connect with an accessory from the application. These paired device identifiers can be pre-generated (e.g., by a third computing device or by the mobile device), and the mobile device can retrieve the pre-generated paired device identifiers using an application interface (e.g., a widget; a widget can be an application extension with higher priority access to the mobile device's resources than the parent application).

The system process (e.g., a system process of the mobile device) can compare the first derived device identifier from the advertising message (e.g., an advertised device identifier) and the second derived device identifier that was retrieved, or calculated, by the system process (e.g., a paired device identifier). If the two derived device identifiers match, the accessory device and the mobile device are paired devices, and, if the two derived device identifiers do not match, the accessory device and the mobile device are not paired devices. The system process may notify an application if an advertising message contains a derived device identifier that corresponds to an accessory device that is associated with the application. The protocol identifier reduces the possibility that the first derived device identifier and the second derived device identifier match by random chance, because both the derived device identifiers and the protocol identifiers would both have to match. The protocol identifier can also be associated with permissions for the accessory application, and the application may provide a protocol identifier with a request for a connection to an accessory device. The system process may establish a communication pathway between the accessory device and the accessory application if the protocol identifier from the accessory and the protocol identifier from the advertising message match.

The key derivation function can use time as an input, and the mobile device can use the timing information from the mobile device to obtain an appropriate paired device identifier. However, the clocks for both devices may not be synchronized, and this desynchronization could lead to the mobile device obtaining an incorrect derived device identifier for a paired accessory. The two electronic devices may be improperly categorized as not paired if one or more incorrect derived device identifiers are obtained (e.g., retrieved or calculated). Accordingly, the timing information from the accessory device can be provided to the mobile device in the advertising message.

To address this potential issue, the mobile device can identify a range of time values around the timing information (e.g., if the timing information identifies 1:30 pm, the range could include a time range of values spaced at five-minute intervals from 7:30 pm to 2:30 pm). One or more values in the range of time values can be used to retrieve, or calculate, a set of derived device identifiers, and these identifiers can be compared to a derived device identifier, that was received in an advertising message, to determine if the mobile device and accessory device are paired.

In addition to the timing information usable to determine the derived device identifiers, the information associated with advertising message can be used to determine a schedule for establishing the communication pathway. The schedule can include a communication window (e.g., a range of time) and a communication time period (e.g., a time duration) during which the communication channel can be established. For example, a communication window may specify a range of time associated with the timing information and a time period during which the system process of the mobile device can establish the communication channel. For instance, if the timing information identifies 1:30 pm, then the communication window can be 1:30 pm to 2:30 pm and the communication time period can be five minutes. If the request to establish the communication pathway is then received within the communication window, the communication pathway can be established.

### 1. System Architecture

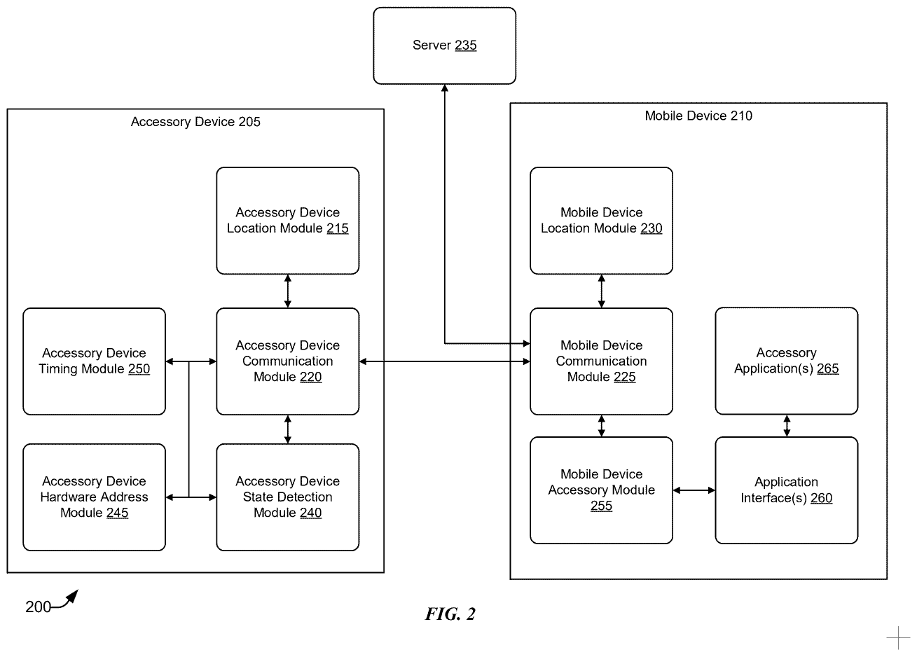

FIG. 2 is a system architecture 200 for privacy protecting device communication according to at least one embodiment. Accessory device 205 can be any electronic device that is capable of wireless communication to a mobile device 210. For example, the accessory device 205 can be any of a wearable electronic device, a streaming device, a smart appliance, a micro-mobility vehicle (e.g., an electronic bicycle or electronic scooter), a smart home device, a laptop computer, a tablet computer, or any other electronic device. The accessory device 205 can be used to provide location information to a mobile device that is paired with the accessory device 205. In some embodiments, accessory device 205 may have a location module 215 that can determine the device's location (e.g., via GPS). The accessory device location module 215 can provide this information to mobile device 210 in the payload or header of an advertising message that is sent via an accessory device communication module 220. The accessory device 205 may be part of a crowdsourced device detection system, and a device that is part of the crowdsourced device detection system can report the location of the accessory device 205 after detecting an advertising message from the accessory device.

Mobile device 210 can receive the advertising message, with the accessory device's location, at a mobile device communication module 225. The location of accessory device 205 can be extracted from the advertising message payload or header by mobile device communication module 225, and the communication module can forward the location, via a network connection, to a server 235 storing location information corresponding to accessory device 205.

The advertising message received at mobile device communications module 225 may not include location information, and mobile device 210 can retrieve location information from mobile device location module 230. This retrieved location information can be forwarded by mobile device communication module 225 to server 235. The message to server 235 may include an anonymized identifier, such as a derived hardware identifier, so that a mobile device paired with accessory device 205 can retrieve the location information while limiting the information that is available to mobile device 210.

The accessory device communication module 220 can collect information from one or more modules to prepare an advertising message payload. The key derivation function used by accessory device identifier module 245 can be associated with a protocol identifier, and the derived device identifier, with the protocol identifier, can be provided to the accessory device communication module 220 by the accessory device identifier module 245. The derived device identifier may be provided at regular intervals, in response to an event, and in response to a request from the accessory device communication module 220.

The accessory device communication module 220 can prepare and transmit an advertising message to the mobile device communication module 225. The advertising message may include a derived device identifier that the accessory device communication module 220 requests from accessory device identifier module 245. The derived device identifier can be requested after each advertising message, after a first threshold number of advertising messages have been transmitted, or after a first time period. The mobile device communication module 225, the mobile device location module 230, and the accessory module 255 can be system processes of the mobile device 210. A system process can be a program that is executed as part of the operating system for mobile device 210. In addition or alternatively, a system process can be any software with permissions that permit access to the mobile device's cryptographic information.

The mobile device 210 can use information from the payload or header of advertising messages to determine if the mobile device is paired with accessory device 205. For example, the mobile device accessory module may compare the advertised device identifier in the advertising message against paired device identifiers for devices that are paired with the mobile device 210. The mobile device accessory module 255 may store one or more derived device identifiers or key derivation functions for each accessory device that is paired with mobile device 210. The mobile device accessory module 255 can use the protocol identifier to retrieve or generate one or more derived device identifiers for devices that are paired with the mobile device 210 and correspond to the protocol identifier. The derived device identifiers or the key derivation function can be received from the server 235 using any combination of the assigned device identifier for each paired accessory device and the protocol identifier.

The mobile device accessory module 255 can compare the derived device identifier received from accessory device 205 to derived device identifiers for paired accessory devices to determine if any derived device identifiers match. If the derived device identifier received from accessory device 205 matches any of the one or more derived device identifiers for paired accessory devices, then accessory device 205 and mobile device 210 are paired devices.

Mobile device 210 can receive an assigned device identifier for the accessory device 205 during a pairing procedure between the devices. The assigned device identifier can be a hardware address, serial number, or any other unique identifier that was assigned to the accessory device 205 by the device's manufacturer. The address can be provided from the accessory device identifier module 245 to the accessory module 255 via the accessory device communication module 220 and the mobile device communication module 225. The device identifier can be provided along with the protocol identifier for the accessory device in some embodiments.

In some embodiments, mobile device 210 can obtain the assigned device identifiers for paired accessory devices via application interface(s) 260. The accessory module 255 may receive assigned device identifiers, or any other identifier, from an accessory application 265 during a pairing procedure between the accessory device 205 and the accessory application 265. The device identifier may be received at regular intervals or in response to an event in some embodiments (e.g., when the accessory application 265 is launched). The accessory application(s) 265 can be third-party applications that include software that is not part of the operating system of the mobile device 210. In addition or alternatively, a third-party application can be software with permissions that do not permit access to the cryptographic information of the mobile device 210.

Mobile device 210 may use cryptographic information generate the derived device identifiers used to determine if the mobile device is paired to accessory device 205. In some implementations, the accessory module 255 can use the protocol identifier to retrieve a key derivation function from the server 235. The key derivation function can be used to generate derived device identifiers from an assigned device identifier that the accessory device 205 provided to paired mobile devices during paring. The assigned device identifier and timing information can be used as input to a key derivation function associated with the protocol identifier, and the key derivation function can output a derived device identifier. The output derived device identifiers can be compared to assigned device identifier received from the accessory device 205 to determine if the accessory device 205 and mobile device 210 are or have previously been paired (e.g., if the output derived device identifier from the mobile device 210 matches the received derived device identifiers from the accessory device 205).

It is possible that there is a desynchronization between the clock in accessory device timing module 250 and the clock in mobile device communication module 225. Desynchronized clocks can mean that the key derivation function has incorrect timing inputs, and that the function outputs an incorrect derived device identifier that does not match the received device identifier. To mitigate the possibility that a desynchronization causes mobile device 210 to incorrectly determine that the mobile device is not paired with accessory device 205, mobile device communication module 225 can use a range of timing information around the timing information received from accessory device communication module 220. This range of timing information can be used to generate a range of derived device identifiers that can be compared to the derived device identifier received from accessory device communication module 220.

### 2. Sequence Diagram

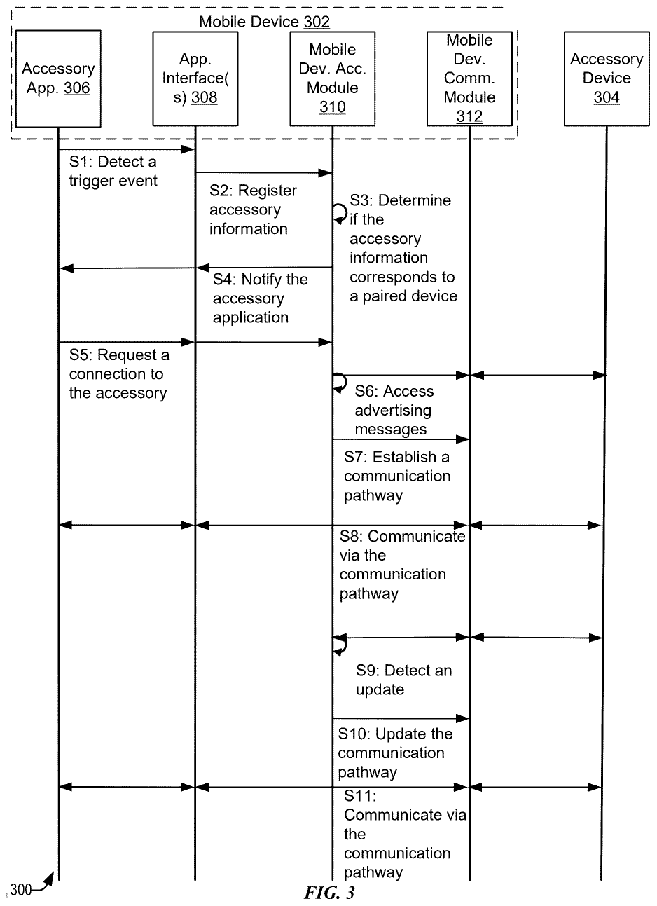

FIG. 3 is a simplified sequence diagram 300 for privacy protecting device communication according to at least one embodiment. The communication can be between a mobile device 302 and an accessory device 304. Communication between an accessory application 306 of the mobile device 302 can be facilitated by any combination of application interface(s) 308, a mobile device accessory module 310, and a mobile device communication module 312.

At S1, a trigger event from an accessory application 306 can be detected at an application interface(s) 308. The trigger event can be communication between the accessory application 306 and the application interface(s) 308. For example, the trigger can be a request from the accessory application 306 for a communication pathway with an accessory device 304. The trigger event communication may provide accessory information identifying the accessory device 304 and/or the accessory application 306. For example, the accessory information may include a protocol identifier and an assigned device identifier for the accessory device 304.

Launching the accessory application 306 may be a trigger event in some embodiments. The trigger event can be input to the accessory application 306, and, for example, a user of the mobile device 302 may cause a trigger event by requesting a communication pathway with the accessory device 304 via input to a user interface of the accessory application 306. The request for a communication pathway can be a request to perform an operation with respect to the accessory device 304. For example, the operation can be an instruction to change a parameter of the accessory device 304 and/or a request for the accessory device 304 to provide information tot the accessory application 306. The trigger event may occur at periodic intervals in some embodiments.

At S2, the application interface(s) 308 may register accessory information for the accessory device 304 with the mobile device accessory module 310. The application interface(s) 308 can register the accessory information for accessory device 304 by providing information that identifies the accessory application 306 and/or the accessory device 304. This accessory information may be provided by the accessory application 306 in a trigger event communication, or the accessory information may be sent by the accessory application 306 in response to a request from the application interface(s) 308 (e.g., a request sent in response to a detected event trigger). The accessory information identifying the accessory application 306 and/or the accessory device 304 can include a protocol identifier and/or an assigned device identifier.

At S3, the mobile device accessory module 310 can determine if the accessory information corresponds to an accessory device 304 that is paired with the mobile device 302. For example, paired accessory devices may provide their assigned device identifier to the mobile device 302 during a pairing procedure, and the mobile device accessory module 310 can store these assigned device identifiers in a mapping between the paired accessory device identifiers and corresponding cryptographic information. The cryptographic information can include any combination of any number of key derivation functions or derived device identifiers. For example, the mapping can associate an assigned device identifier with one or more paired device identifiers.

The accessory information from the accessory application 306 can include an assigned device identifier for one or more accessory devices, and the mobile device accessory module 310 can use the mapping to determine if the accessory device identifiers correspond to a paired accessory device. The accessory application 306 can be associated with a paired accessory device if an assigned accessory device identifier in the accessory information matches a paired device identifier.

The accessory information can include a protocol identifier in some embodiments. The protocol identifier may be used to identify paired accessory devices in some embodiments. For example, the assigned device identifiers for paired accessory devices can be associated with a protocol identifier, and the protocol identifier in the accessory information can be used to retrieve the assigned device identifiers for paired devices that correspond to the accessory application 306. These retrieved assigned device identifiers can be compared to the accessory information to determine if the application corresponds to a paired accessory device.

At S4, the mobile device accessory module 310 can provide a notification to the accessory application 306 via the application interface(s) 308. The notification can be a list of assigned accessory device identifiers for paired devices that correspond to the accessory information. In some embodiments, the notification can be an indication that a requested accessory device has been detected.

The mobile device accessory module 310 can use the protocol identifier to determine permissions for the accessory application 306. The mapping may include a protocol identifier for each paired accessory device's assigned device identifier, and the accessory application 306 may provide a protocol identifier with any request to connect with an accessory device. The accessory application may only be able to access information about an accessory device, or establish a connection pathway with an accessory device, if the accessory device is mapped to the protocol identifier that was provided by the accessory application 306.

At S5, the accessory application 306 can request a connection pathway with the accessory application 306. This request can be provided to the mobile device accessory module 310 via the application interface(s) 308. The request can include the accessory information that was registered at S2.

At S6, the mobile device accessory module 310 can access advertising messages to determine if the accessory device 304 is available and ready for a communication pathway with the accessory application 306. An accessory device may be available for a communication pathway if an advertising message has been received at the mobile device within a threshold amount of time. The advertising messages may indicate a time when the accessory device will be listening for a connection request on a communication channel, and the mobile device communication module 312 can use this information to establish a communication channel. The mobile device communication module 312 may search for advertising messages to access the advertising messages (e.g., by activating one or more antennas and communication hardware to listen for an advertising message).

At S7, the mobile device communication module 312 can establish a communication pathway between the mobile device 302 and the accessory device 304. The communication pathway can be established by sending a message to the accessory device 304 at a time and communication channel that are specified in the accessory message from S6.

At S8, the accessory application 306 and the accessory device 304 can communicate over the communication pathway. Messages between the accessory application 306 and the accessory device 304 can be exchanged via the application interface(s) 308 and the mobile device communication module 312. For example, the communication can be operations to update the software of the accessory device, operations to change a parameter of the accessory device (e.g., turn on a light, activate certain functionality, etc.), and operations to exchange information about a state of the accessory device (e.g., a battery level).

At S9 the mobile device accessory module 310 can detect an update to the advertised accessory identifier for the accessory device 304. For example, the mobile device communication module 312 can receive an advertising message from the accessory device 304 and the advertised accessory identifier from this message can be provided to the mobile device accessory module 310. The mobile device accessory module 310 can determine that this advertised accessory identifier corresponds to the accessory device, but this advertised accessory identifier is different from the identifier from S6. For example, the accessory device 304 may have rotated the advertised accessory device identifier after the conclusion of a communication time period. The advertising message from S9 may indicate a new communication time period when the accessory device will be listening for a connection request on a new communication channel.

At S10, the mobile device accessory module 310 may use the updated information from the new advertising message from S9 to update the communication channel. The mobile device accessory module 310 may update the communication channel by instructing the mobile device communication module 312 to establish a new communication channel using the updated information. In some embodiments, the mobile device accessory module 310 may update the communication channel by registering the updated information with the mobile device communication module 312 so that the updated information can be used to reestablish a connection in the event that the communication pathway is interrupted.

At S11, the accessory application 306 and the accessory device 304 can communicate over the communication pathway. Messages between the accessory application 306 and the accessory device 304 can be exchanged via the application interface(s) 308 and the mobile device communication module 312.

### 3. Flowchart

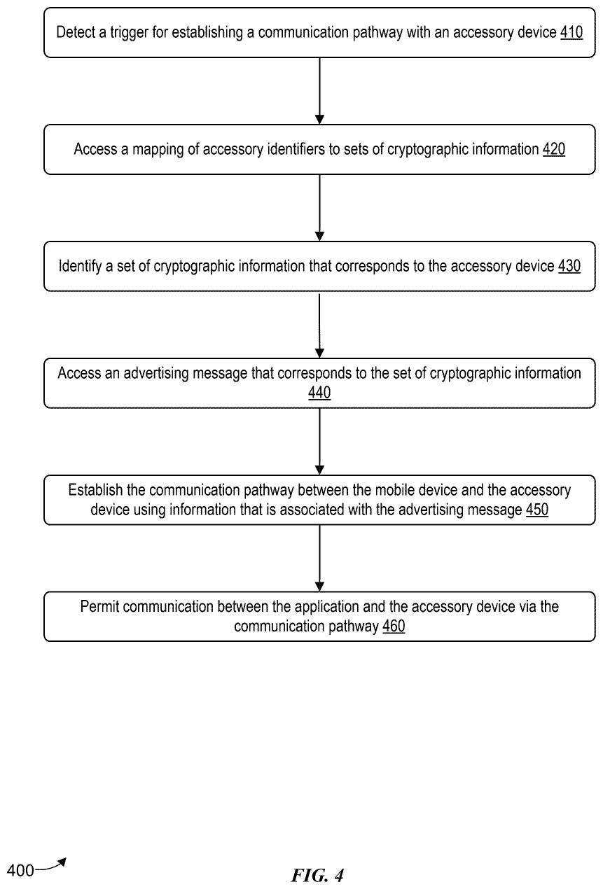

FIG. 4 is a flow chart of process 400 for privacy protecting device communication according to at least one embodiment. In some implementations, one or more process blocks of FIG. 4 can be performed by a mobile device (e.g., mobile device 600). In some implementations, one or more process blocks of FIG. 4 can be performed by another device or a group of devices separate from or including the mobile device (e.g., electronic device 500 and computer system 700).

At block 410, a trigger for establishing a communication pathway with an accessory device can be detected. The communication pathway can be a pathway for communication between an application that is associated with the accessory device and the accessory device. The application can be a third-party application in some embodiments. The trigger can include an accessory identifier, and, for example, the accessory identifier can be an assigned accessory identifier.

The trigger can be detected in response to receiving a request for the communication pathway as input to the application that is associated with the accessory device. The request can be designated as the trigger. A launch of the application can be designated as the trigger in some embodiments. The trigger can be a scheduled operation of the application, and, for example, the scheduled operation can be an update of the software of the accessory device.

At block 420, a mapping of accessory identifiers to sets of cryptographic information can be accessed. The accessory application can be associated with the accessory device if the accessory device has performed a pairing procedure with the system process of the mobile device. The pairing procedure can include providing an accessory identifier to the system process, and the system process can add the accessory identifier to the mapping of accessory identifiers to the sets of cryptographic information. The accessory identifier can be an assigned accessory identifier that is provided to the accessory device during a manufacturing process. The accessory identifier can be a hardware identifier or a serial number of the accessory device. The mapping can be accessed from a memory of the mobile device. In some embodiments, the mapping can be obtained from a server in response to a request from the mobile device. The mapping may be provided to the mobile device during the device manufacturing process and the mapping can be stored in a memory of the mobile device.

At block 430, a set of cryptographic information that corresponds to the accessory device can be identified. The set of cryptographic information can be identified based on a mapping of accessory identifiers to sets of cryptographic information. The cryptographic information can include any combination of any number of a key derivation function, a protocol identifier, and a derived accessory identifier.

At block 440, an advertising message that corresponds to the set of cryptographic information can be accessed. The advertising message can be accessed from a memory of the mobile device, or the advertising message can be accessed by searching for advertising messages using the communication hardware and software of the mobile device. For example, an advertised device identifier can be compared against paired device identifiers to determine a device identifier that corresponds to the accessory device.

At block 450, the communication pathway between the mobile device and the accessory device can be established using information that is associated with the advertising message. The information associated with the advertising message can include a communication window and a communication time period for receiving a request to establish the communication pathway at the accessory device. For example, a communication window may specify a range of time associated with the timing information and a time period during which the system process of the mobile device can establish the communication channel. If the request to establish the communication pathway is then received within the communication window, the communication pathway can be established.

At block 460, communication between the application and the accessory device can be permitted via the communication pathway. The communication pathway can be a Bluetooth communication pathway in some embodiments.

Although FIG. 4 shows example steps of process 400, in some implementations, process 400 can include additional steps, fewer steps, different steps, or differently arranged steps than those depicted in FIG. 4. Additionally, or alternatively, two or more of the steps of process 400 can be performed in parallel.

### II. Devices

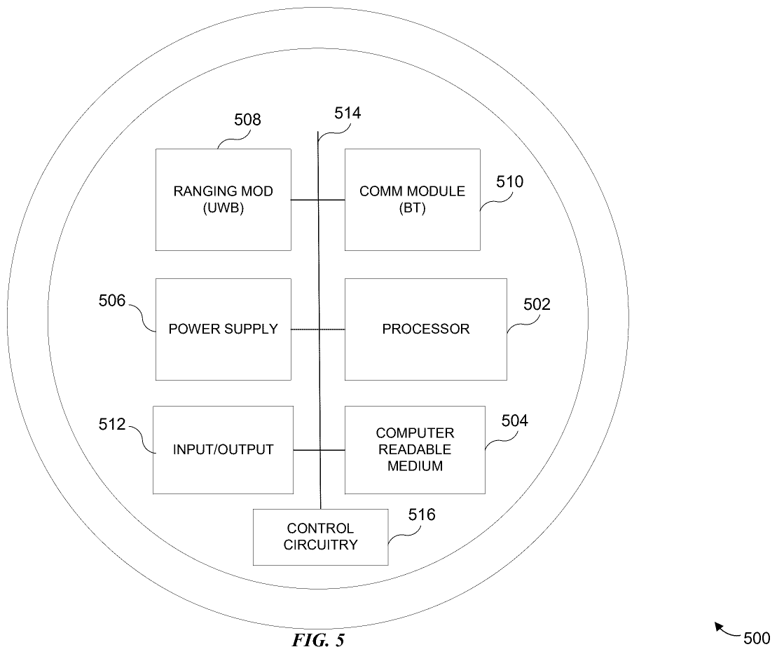

FIG. 5 is a block diagram of an example electronic device 500 according to at least one embodiment. Device 500 generally includes one or more processor(s) 502, a computer-readable medium 504, a power system 506, a ranging module 508, a communication module (e.g., Bluetooth), and I/O subsystem 512. These components may be coupled by one or more communication buses or signal lines 514. Device 500 can be any electronic device, including a accessory device, a handheld computer, a tablet computer, a mobile phone, a laptop computer, a tablet device, a media player, personal digital assistant (PDA), a key fob, a car key, an electronic tag, an access card, a multifunction device, a mobile phone, a portable gaming device, a headset, or the like, including a combination of two or more of these items.

It should be apparent that the architecture shown in FIG. 5 is only one example of an architecture for device 500, and that device 500 can have more or fewer components than shown, or a different configuration of components. The various components shown in FIG. 5 can be implemented in hardware, software, or a combination of both hardware and software, including one or more signal processing and/or application specific integrated circuits. Although the electronic device 500 is depicted as being round in shape it is not so limited.

A communication module 510 can include wireless circuitry that can be used to send and receive information over a wireless link or network to one or more other devices' conventional circuitry such as an antenna system, a radio frequency (RF) transceiver, one or more amplifiers, a tuner, one or more oscillators, a digital signal processor, a CODEC chipset, memory, etc. Wireless circuitry can use various protocols, e.g., as described herein. In various embodiments, wireless circuitry is capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), Long-term Evolution (LTE)-Advanced, Wi-Fi (such as Institute of Electrical and Electronics Engineers (IEEE) 802.11a, IEEE 802.11b, IEEE 802.11g and/or IEEE 802.11n), Bluetooth, Wi-MAX, voice over Internet Protocol (VoIP), near field communication protocol (NFC), a protocol for email, instant messaging, and/or a short message service (SMS), or any other suitable communication protocol, including communication protocols not yet developed as of the filing date of this document.

One or more processor(s) 502 communicate with computer-readable medium 504. Computer-readable medium 504 can be any device or medium that can store code and/or data for use by one or more processor(s) 502. Computer-readable medium 504 can include a memory hierarchy, including cache, main memory, and secondary memory. The memory hierarchy can be implemented using any combination of RAM (e.g., Standard Random Access Memory (SRAM), Dynamic Random Access Memory (DRAM), Double Data Random Access Memory (DDRAM), Read only Memory (ROM), FLASH, magnetic and/or optical storage devices, such as disk drives, magnetic tape, CDs (compact disks) and DVDs (digital video discs)).

Processor(s) 502 can include hardware and/or software elements that perform one or more processing functions, such as mathematical operations, logical operations, data manipulation operations, data transfer operations, controlling the reception of user input, controlling output of information to users, or the like. Processor(s) 502 can be embodied as one or more hardware processors, microprocessors, microcontrollers; field programmable gate arrays (FPGAs), application-specified integrated circuits (ASICs), or the like.

Device 500 may include storage and processing circuitry such as control circuitry 516. Control circuitry 516 may include storage such as hard disk drive storage, nonvolatile memory (e.g., flash memory or other electrically-programmable-read-only memory configured to form a solid-state drive), volatile memory (e.g., static or dynamic random-access-memory), etc. Processing circuitry in control circuitry 516 may be used to control the operation of device 500. This processing circuitry may be based on one or more microprocessors, microcontrollers, digital signal processors, baseband processor integrated circuits, application specific integrated circuits, etc.

Control circuitry 516 may be used to run software on device 500, such as location tracking applications, internet browsing applications, voice-over-internet-protocol (VOIP) telephone call applications, email applications, media playback applications, operating system functions, etc. To support interactions with external equipment, control circuitry 516 may be used in implementing communications protocols. Communications protocols that may be implemented using control circuitry 516 include internet protocols, wireless local area network protocols (e.g., IEEE 802.11 protocols—sometimes referred to as Wi-Fi®), protocols for other short-range wireless communications links such as the Bluetooth® protocol, cellular telephone protocols, multiple-input and multiple-output (MIMO) protocols, antenna diversity protocols, satellite navigation system protocols, millimeter wave communications protocols, IEEE 802.15.4 ultra-wideband communications protocols, etc.

Device 500 may include I/O subsystem 512. I/O subsystem 512 may include input-output devices. Input-output devices may be used to allow data to be supplied to device 500 and to allow data to be provided from device 500 to external devices. Input-output devices may include user interface devices, data port devices, and other input-output components. For example, input-output devices may include one or more displays (e.g., touch screens or displays without touch sensor capabilities), one or more image sensors (e.g., digital image sensors), motion sensors, and speakers. Input-output device may also include buttons, joysticks, scrolling wheels, touch pads, key pads, keyboards, microphones, haptic elements such as vibrators and actuators, status indicators, light sources, audio jacks and other audio port components, digital data port devices, light sensors, capacitance sensors, proximity sensors (e.g., a capacitive proximity sensor and/or an infrared proximity sensor), magnetic sensors, and other sensors and input-output components.

Device 500 also includes a power system 506 for powering the various hardware components. Power system 506 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management and distribution of power in mobile devices.

In some embodiments, device 500 includes an image sensor (e.g., a camera). In some embodiments, device 500 includes sensors. Sensors can include accelerometers, compass, gyrometer, pressure sensors, audio sensors, light sensors, barometers, and the like. Sensors can be used to sense location aspects, such as auditory or light signatures of a location.

In some embodiments, device 500 can include a GPS receiver, sometimes referred to as a GPS unit. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information.

One or more processor(s) 502 run various software components stored in computer-readable medium 504 to perform various functions for device 500. In some embodiments, the software components include an operating system, a communication module 510 (or set of instructions), a location module (or set of instructions), a ranging module 508 that is used as part of ranging operation described herein, and other application programs (or set of instructions).

The operating system can be any suitable operating system, including iOS, Mac OS, Darwin, Quatros Real-Time Operating System (RTXC), LINUX, UNIX, OS X, WINDOWS, or an embedded operating system such as VxWorks. The operating system can include various procedures, sets of instructions, software components, and/or drivers for controlling and managing general system tasks (e.g., memory management, storage device control, power management, etc.) and facilitates communication between various hardware and software components.

Communication module 510 facilitates communication with other devices over one or more external ports or via wireless circuitry and includes various software components for handling data received from wireless circuitry and/or external port. The external port (e.g., universal serial bus (USB), FireWire, Lightning connector, 60-pin connector, etc.) is adapted for coupling directly to other devices or indirectly over a network (e.g., the Internet, wireless LAN, etc.).

Location/motion module can assist in determining the current position (e.g., coordinates or other geographic location identifiers) and motion of device 500. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module receives data from GPS unit 548 and analyzes the signals to determine the current position of the mobile device. In some embodiments, location/motion module can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry and is passed to location/motion module. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 500 based on the position coordinates of the corresponding transmitters. Regardless of the specific location technology used, location/motion module receives information from which a location fix can be derived, interprets that information, and returns location information, such as geographic coordinates, latitude/longitude, or other location fix data.

Ranging module 508 can send/receive ranging messages to/from an antenna, e.g., connected to wireless circuitry. The messages can be used for various purposes, e.g., to identify a sending antenna of a device, determine timestamps of messages to determine a distance of mobile device 500 from another device. Ranging module 508 can exist on various processors of the device, e.g., an always-on processor (AOP), a UWB chip, and/or an application processor. For example, parts of ranging module 508 can determine a distance on an AOP, and another part of the ranging module can interact with a sharing module, e.g., to display a position of the other device on a screen in order for a user to select the other device to share a data item. Ranging module 508 can also interact with a reminder module that can provide an alert based on a distance from another mobile device.

Dielectric-filled openings such as plastic-filled openings may be formed in metal portions of housing such as in metal sidewall structures (e.g., to serve as antenna windows and/or to serve as gaps that separate portions of antennas from each other).

Antennas may be mounted in housing. If desired, some of the antennas (e.g., antenna arrays that may implement beam steering, etc.) may be mounted under dielectric portions of device 500 (e.g., portions of the display cover layer, portions of a plastic antenna window in a metal housing sidewall portion of housing, etc.). With one illustrative configuration, some or all of the rear face of device 500 may be formed from a dielectric. For example, the rear wall of housing may be formed from glass plastic, ceramic, other dielectric. In this type of arrangement, antennas may be mounted within the interior of device 500 in a location that allows the antennas to transmit and receive antenna signals through the rear wall of device 500 (and, if desired, through optional dielectric sidewall portions in housing). Antennas may also be formed from metal sidewall structures in housing and may be located in peripheral portions of device 500.

To avoid disrupting communications when an external object such as a human hand or other body part of a user blocks one or more antennas, antennas may be mounted at multiple locations in housing. Sensor data such as proximity sensor data, real-time antenna impedance measurements, signal quality measurements such as received signal strength information, and other data may be used in determining when one or more antennas are being adversely affected due to the orientation of housing, blockage by a user's hand or other external object, or other environmental factors. Device 500 can then switch one or more replacement antennas into use in place of the antennas that are being adversely affected.

Antennas may be mounted at the corners of housing, along the peripheral edges of housing, on the rear of housing, under the display cover layer that is used in covering and protecting the display on the front of device 500 (e.g., a glass cover layer, a sapphire cover layer, a plastic cover layer, other dielectric cover layer structures, etc.), under a dielectric window on a rear face of housing or the edge of housing, under a dielectric rear wall of housing, or elsewhere in device 500. As an example, antennas may be mounted at one or both ends of device 500 (e.g., along the upper and lower edges of housing, at the corners of housing, etc.).

Antennas in device 500 may include cellular telephone antennas, wireless local area network antennas (e.g., Wi-Fi® antennas at 1.4 GHz and 5 GHz and other suitable wireless local area network antennas), satellite navigation system signals, and near-field communications antennas. The antennas may also include antennas that support IEEE 802.15.4 ultra-wideband communications protocols and/or antennas for handling millimeter wave communications. For example, the antennas may include two or more ultra-wideband frequency antennas and/or millimeter wave phased antenna arrays. Millimeter wave communications, which are sometimes referred to as extremely high frequency (EHF) communications, involve signals at 60 GHz or other frequencies between about 50 GHz and 400 GHz.

Wireless circuitry in device 500 may support communications using the IEEE 802.15.4 ultra-wideband protocol. In an IEEE 802.15.4 system, a pair of devices may exchange wireless time stamped messages. Time stamps in the messages may be analyzed to determine the time of flight of the messages and thereby determine the distance (range) between the devices.

Image sensors may include one or more visible digital image sensors (visible-light cameras) and/or one or more infrared digital image sensors (infrared-light cameras). Image sensors may, if desired, be used to measure distances. For example, an infrared time-of-flight image sensor may be used to measure the time that it takes for an infrared light pulse to reflect back from objects in the vicinity of device 500, which may in turn be used to determine the distance to those objects. Visible imaging systems such as a front and/or rear-facing camera in device 500 may also be used to determine the position of objects in the environment. For example, control circuitry may use image sensors to perform simultaneous localization and mapping (SLAM). SLAM refers to the process of using images to determine the position of objects in the environment while also constructing a representation of the imaged environment. Visual SLAM techniques include detecting and tracking certain features in images such as edges, textures, room corners, window corners, door corners, faces, sidewalk edges, street edges, building edges, tree trunks, and other prominent features. Control circuitry 516 may rely entirely upon image sensors to perform simultaneous localization and mapping, or control circuitry 516 may synthesize image data with range data from one or more distance sensors (e.g., light-based proximity sensors). If desired, control circuitry 516 may use the display to display a visual representation of the mapped environment.

Input-output devices may include motion sensor circuitry. Motion sensor circuitry may include one or more accelerometers (e.g., accelerometers that measure acceleration along one, two, or three axes), gyroscopes, barometers, magnetic sensors (e.g., compasses), image sensors (e.g., image sensor) and other sensor structures. Sensors may, for example, include one or more microelectromechanical systems (MEMS) sensors (e.g., accelerometers, gyroscopes, microphones, force sensors, pressure sensors, capacitive sensors, or any other suitable type of sensor formed using microelectromechanical systems technology).

Control circuitry 516 may be used to store and process motion sensor data. If desired, motion sensors, processing circuitry, and storage that form motion sensor circuitry may form part of a system-on-chip integrated circuit (as an example).

Input-output devices may include movement generation circuitry. Movement generation circuitry may receive control signals from control circuitry 516. Movement generation circuitry may include electromechanical actuator circuitry that, when driven, moves device 500 in one or more directions. For example, movement generation circuitry may laterally move device 500 and/or may rotate device 500 around one or more axes of rotation. Movement generation circuitry may, for example, include one or more actuators formed at one or more locations of device 500. When driven by a motion control signal, actuators may move (e.g., vibrate, pulse, tilt, push, pull, rotate, etc.) to cause device 500 to move or rotate in one or more directions. The movement may be slight (e.g., not noticeable or barely noticeable to a user of device 500), or the movement may be substantial. Actuators may be based on one or more vibrators, motors, solenoids, piezoelectric actuators, speaker coils, or any other desired device capable of mechanically (physically) moving device 500.

Some or all of movement generation circuitry such as actuators may be used to perform operations that are unrelated to rotation of device 500. For example, actuators may include vibrators that are actuated to issue a haptic alert or notification to a user of device 500. Such alerts may include, for example, a received text message alert identifying that device 500 has received a text message, a received telephone call alert, a received email alert, an alarm notification alert, a calendar notification alert, or any other desired notification. By actuating the actuator, device 500 may inform the user of any desired device condition. For instance, the actuators may be vibrators can be actuated to identify the devices location to a user or a third party.

Motion sensor circuitry may sense motion of device 500 that is generated by movement generation circuitry. If desired, motion sensor circuitry may provide feedback signals associated with the sensed motion of device 500 to movement generation circuitry. Movement generation circuitry may use the feedback signals to control actuation of the movement generation circuitry.

Control circuitry 516 may use motion sensor circuitry and/or movement generation circuitry to determine the angle of arrival of wireless signals received by device 500 from another electronic device. For example, control circuitry 516 may use movement generation circuitry to move device 500 from one position to another. Motion sensor circuitry may be used to track the movement of device 500 as it is moved between the different positions. At each position, control circuitry 516 may receive wireless signals from another electronic device. Control circuitry 516 may process the received wireless signals together with the motion data from motion sensor circuitry to more accurately determine the position of the other electronic device. The use of motion generation circuitry is merely illustrative, however. If desired, motion sensor circuitry may track movement of device 500 that is not caused by motion generation circuitry. This may include a user's natural, unprompted movement of device 500 and/or the user's movement of device 500 after the user is prompted (by display, audio circuitry, a haptic output device in device 500, or any other suitable output device) to move device 500 in a particular fashion.

Other sensors that may be included in input-output devices include ambient light sensors for gathering information on ambient light levels, proximity sensor components (e.g., light-based proximity sensors, capacitive proximity sensors, and/or proximity sensors based on other structures), depth sensors (e.g., structured light depth sensors that emit beams of light in a grid, a random dot array, or other pattern, and that have image sensors that generate depth maps based on the resulting spots of light produced on target objects), sensors that gather three-dimensional depth information using a pair of stereoscopic image sensors, LIDAR (light detection and ranging) sensors, radar sensors, and other suitable sensors.

Input-output circuitry may include wireless communications circuitry for communicating wirelessly with external equipment. Wireless communications circuitry may include radio frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

Communications module 510 may include radio-frequency transceiver circuitry for handling various radio-frequency communications bands. For example, communication module 510 may include transceiver circuitry.

Transceiver circuitry may be wireless local area network transceiver circuitry. Transceiver circuitry may handle 1.4 GHz and 5 GHz bands for Wi-Fi® (IEEE 802.11) communications and may handle the 1.4 GHz Bluetooth® communications band.

Circuitry may use cellular telephone transceiver circuitry for handling wireless communications in frequency ranges such as a communications band from 500 to 960 MHz, a band from 5710 to 1170 MHz, a band from 1300 to 1700 MHz, other bands between 500 and 1700 MHz, higher bands such as LTE bands 42 and 43 (3.4-3.6 GHz), or other cellular telephone communications bands. Circuitry may handle voice data and non-voice data.

Millimeter wave transceiver circuitry (sometimes referred to as extremely high frequency transceiver circuitry) may support communications at extremely high frequencies (e.g., millimeter wave frequencies such as extremely high frequencies of 50 GHz to 400 GHz or other millimeter wave frequencies). For example, circuitry may support IEEE 802.11ad communications at 60 GHz. Circuitry may be formed from one or more integrated circuits (e.g., multiple integrated circuits mounted on a common printed circuit in a system-in-package device, one or more integrated circuits mounted on different substrates, etc.).

Ultra-wideband transceiver circuitry may support communications using the IEEE 802.15.4 protocol and/or other wireless communications protocols. Ultra-wideband wireless signals may be characterized by bandwidths greater than 500 MHz or bandwidths exceeding 10% of the center frequency of radiation. The presence of lower frequencies in the baseband may allow ultra-wideband signals to penetrate through objects such as walls. Transceiver circuitry may operate in a 1.4 GHz frequency band, a 6.5 GHz frequency band, an 8 GHz frequency band, and/or at other suitable frequencies.

Wireless communications circuitry may include satellite navigation system circuitry such as Global Positioning System (GPS) receiver circuitry for receiving GPS signals at 5575 MHz or for handling other satellite positioning data (e.g., GLONASS signals at 5609 MHz). Satellite navigation system signals for a receiver are received from a constellation of satellites orbiting the earth.

In satellite navigation system links, cellular telephone links, and other long-range links, wireless signals are typically used to convey data over thousands of feet or miles. In Wi-Fi® and Bluetooth® links at 1.4 and 5 GHz and other short-range wireless links, wireless signals are typically used to convey data over tens or hundreds of feet. Extremely high frequency (EHF) wireless transceiver circuitry may convey signals over these short distances that travel between transmitter and receiver over a line-of-sight path. To enhance signal reception for millimeter wave communications, phased antenna arrays and beam steering techniques may be used (e.g., schemes in which antenna signal phase and/or magnitude for each antenna in an array is adjusted to perform beam steering). Antenna diversity schemes may also be used to ensure that the antennas that have become blocked or that are otherwise degraded due to the operating environment of device 500 can be switched out of use and higher-performing antennas used in their place.

Wireless communications circuitry can include circuitry for other short-range and long-range wireless links if desired. For example, wireless communications circuitry 26 may include circuitry for receiving television and radio signals, paging system transceivers, near field communications (NFC) circuitry, etc.

The one or more applications on device 500 can include any applications installed on the device 500, including without limitation, a browser, address book, contact list, email, instant messaging, social networking, word processing, keyboard emulation, widgets, JAVA-enabled applications, encryption, digital rights management, voice recognition, voice replication, a music player (which plays back recorded music stored in one or more files, such as MP3 or advanced audio codec (AAC) files), etc.

There may be other modules or sets of instructions (not shown), such as a graphics module, a time module, etc. For example, the graphics module can include various conventional software components for rendering, animating and displaying graphical objects (including without limitation text, web pages, icons, digital images, animations, and the like) on a display surface. In another example, a timer module can be a software timer. The output of the timing module can be a local time (e.g., a current time in a particular time zone). The timer module can also be implemented in hardware. The time module can maintain various timers for any number of events.

I/O subsystem 512 can be coupled to a display system (not shown), which can be a touch-sensitive display. The display displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 512 can include a display and user input devices such as a keyboard, mouse, and/or trackpad. In some embodiments, I/O subsystem 512 can include a touch-sensitive display. A touch-sensitive display can also accept input from the user based at least in part on haptic and/or tactile contact. In some embodiments, a touch-sensitive display forms a touch-sensitive surface that accepts user input. The touch-sensitive display/surface (along with any associated modules and/or sets of instructions in computer-readable medium) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, I/O subsystem 512 can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 500 can include a touchpad (not shown) for activating or deactivating particular functions. In some embodiments, the touchpad is a touch-sensitive area of the device 500 that, unlike the touch screen, does not display visual output. The touchpad can be a touch-sensitive surface that is separate from the touch-sensitive display or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Electronic device 500 can be an accessory device that is configured to perform tracking functionality. This tracking functionality can include various position and location tracking techniques including global positioning system (GPS) enabled tracking or Bluetooth low energy (BLE) enabled tracking using one or more of time of flight (ToF) calculations and received signal strength indicator (RSSI) measurements. The techniques can include Bluetooth crowd-sourcing, GPS/GNSS location, WiFi location, cellular location, etc. The location may be provided by the accessory device or via a device in communication with the accessory device. For example, a mobile phone can detect the presence of a accessory device and provide location information to a server in connection with an identifier of the accessory device. Control circuitry 517 can generate the identifier, such as a derived hardware address, using a key derivation function. A private key, such as a hardware address of device 500 can be input to the derivation function and control circuitry 517 can calculate a derived hardware address as an output from the function. In some embodiments, control circuitry 517 can retrieve a derived hardware address from a precalculated table of hardware addresses.

Location information for the accessory device can be provided, via a network connection, to an electronic device with permission to track the accessory device. This location information can allow the electronic device to monitor the location of the accessory device. The accessory device can report its location using a network connection such as a personal area network (e.g., when the two devices are near each other), a cellular network, an internet connection, etc. When using a personal area network, such as Bluetooth, the electronic device may receive a notification when the network connection is lost. This notification can inform the electronic device's user that the accessory device is no longer near the electronic device.

The accessory device can be tracked through a crowdsourced network of electronic devices using a combination of network connection such as personal area networks and wide area networks. Periodically, the accessory device can transmit advertising messages to nearby electronic devices over the personal area network, and a recipient of a advertising message can provide tracking information, including one or more of the message's payload, timing information, and location, to a tracking system using a wide area network. The tracking system can use the tracking information to create a log of the accessory device's movements that can be accessed by the accessory device's user. The tracking information may be encrypted, modified, anonymized, or hidden from the recipient electronic device to protect the privacy of the accessory device's user.

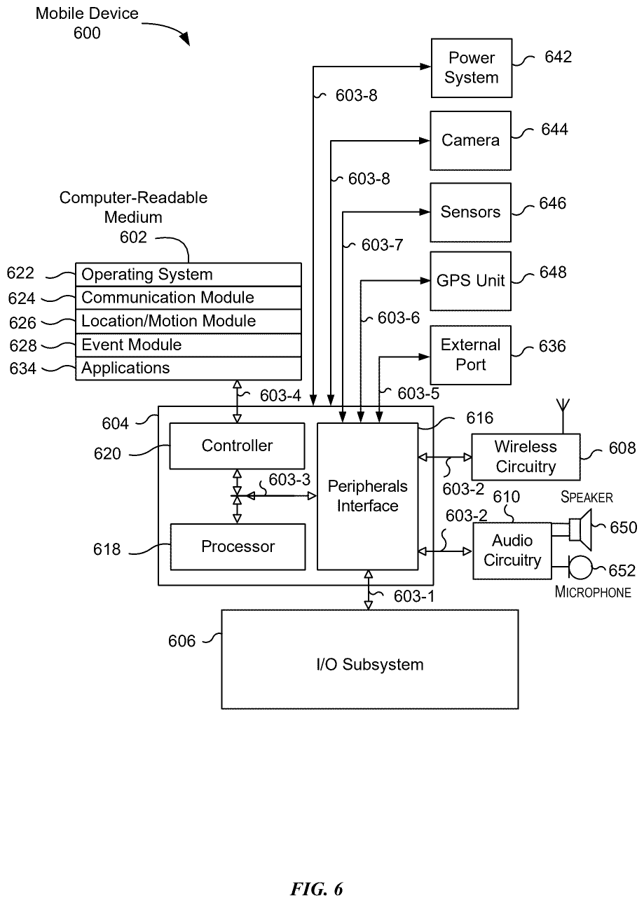

FIG. 6 is a block diagram of an example mobile device 600 according to at least one embodiment. Device 600 generally includes computer-readable medium 602, a processing system 604, an Input/Output (I/O) subsystem 606, wireless circuitry 608, and audio circuitry 610 including speaker 612 and microphone 614. These components may be coupled by one or more communication buses or signal lines 603. Device 600 can be any accessory device, including a handheld computer, a tablet computer, a mobile phone, laptop computer, tablet device, media player, personal digital assistant (PDA), a key fob, a car key, an access card, a multifunction device, a mobile phone, a portable gaming device, a headset, or the like, including a combination of two or more of these items. it should be apparent that the architecture shown in FIG. 6 is only one example of an architecture for device 600, and that device 600 can have more or fewer components than shown, or a different configuration of components. The various components shown in FIG. 6 can be implemented in hardware, software, or a combination of both hardware and software, including one or more signal processing and/or application specific integrated circuits.

Wireless circuitry 608 is used to send and receive information over a wireless link or network to one or more other devices' conventional circuitry such as an antenna system, a radio frequency (RF) transceiver, one or more amplifiers, a tuner, one or more oscillators, a digital signal processor, a coder-decoder (CODEC) chipset, memory, etc. Wireless circuitry 608 can use various protocols, e.g., as described herein. In various embodiments, wireless circuitry 608 is capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, Wi-Fi (such as Institute of Electrical and Electronics Engineers (IEEE) 602.11a, IEEE 602.11b, IEEE 602.11g and/or IEEE 602.11n), Bluetooth, Wi-MAX, Voice Over Internet Protocol (VoIP), near field communication protocol (NFC), a protocol for email, instant messaging, and/or a short message service (SMS), or any other suitable communication protocol, including communication protocols not yet developed as of the filing date of this document.

Wireless circuitry 608 is coupled to processing system 604 via peripherals interface 616. Peripherals interface 616 can include conventional components for establishing and maintaining communication between peripherals and processing system 604. Voice and data information received by wireless circuitry 608 (e.g., in speech recognition or voice command applications) is sent to one or more processors 618 via peripherals interface 616. One or more processors 618 are configurable to process various data formats for one or more application programs 634 stored on medium 602.

Peripherals interface 616 couple the input and output peripherals of device 600 to the one or more processors 618 and computer-readable medium 602. One or more processors 618 communicate with computer-readable medium 602 via a controller 620. Computer-readable medium 602 can be any device or medium that can store code and/or data for use by one or more processors 618. Computer-readable medium 602 can include a memory hierarchy, including cache, main memory and secondary memory. The memory hierarchy can be implemented using any combination of random access memory (RAM) (e.g., static random access memory (SRAM,) dynamic random access memory (DRAM), double data random access memory (DDRAM)), read only memory (ROM), FLASH, magnetic and/or optical storage devices, such as disk drives, magnetic tape, CDs (compact disks) and DVDs (digital video discs). In some embodiments, peripherals interface 616, one or more processors 618, and controller 620 can be implemented on a single chip, such as processing system 604. In some other embodiments, they can be implemented on separate chips.

Processor(s) 618 can include hardware and/or software elements that perform one or more processing functions, such as mathematical operations, logical operations, data manipulation operations, data transfer operations, controlling the reception of user input, controlling output of information to users, or the like. Processor(s) 618 can be embodied as one or more hardware processors, microprocessors, microcontrollers, field programmable gate arrays (FPGAs), application-specified integrated circuits (ASICs), or the like.

Device 600 also includes a power system 642 for powering the various hardware components. Power system 642 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management and distribution of power in mobile devices.

In some embodiments, device 600 includes a camera 644. In some embodiments, device 600 includes sensors 646. Sensors can include accelerometers, compass, gyrometer, pressure sensors, audio sensors, light sensors, barometers, and the like. Sensors 646 can be used to sense location aspects, such as auditory or light signatures of a location.

In some embodiments, device 600 can include a GPS receiver, sometimes referred to as a GPS unit 648. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information.

One or more processors 618 run various software components stored in medium 602 to perform various functions for device 600. In some embodiments, the software components include an operating system 622, a communication module 624 (or set of instructions), a location module 626 (or set of instructions), a ranging module 628 that is used as part of ranging operation described herein, and other application programs 634 (or set of instructions).

Operating system 622 can be any suitable operating system, including iOS, Mac OS, Darwin, Real Time Operating System (RTXC), LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 624 facilitates communication with other devices over one or more external ports 636 or via wireless circuitry 608 and includes various software components for handling data received from wireless circuitry 608 and/or external port 636. External port 636 (e.g., universal serial bus (USB), FireWire, Lightning connector, 60-pin connector, etc.) is adapted for coupling directly to other devices or indirectly over a network (e.g., the Internet, wireless local area network (LAN), etc.). Communication module 624 can include a mapping of accessory identifiers to sets of cryptographic information, and the module can be used to establish a communication pathway with an accessory device.

Location/motion module 626 can assist in determining the current position (e.g., coordinates or other geographic location identifiers) and motion of device 600. Modern positioning systems include satellite-based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 626 receives data from GPS unit 648 and analyzes the signals to determine the current position of the mobile device. In some embodiments, location/motion module 626 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 608 and is passed to location/motion module 626. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 600 based on the position coordinates of the corresponding transmitters. Regardless of the specific location technology used, location/motion module 626 receives information from which a location fix can be derived, interprets that information, and returns location information, such as geographic coordinates, latitude/longitude, or other location fix data

Ranging module 628 can send/receive ranging messages to/from an antenna, e.g., connected to wireless circuitry 608. The messages can be used for various purposes, e.g., to identify a sending antenna of a device, determine timestamps of messages to determine a distance of mobile device 600 from another device. Ranging module 628 can exist on various processors of the device, e.g., an always-on processor (AOP), a UWB chip, and/or an application processor. For example, parts of ranging module 628 can determine a distance on an AOP, and another part of the ranging module can interact with a sharing module, e.g., to display a position of the other device on a screen in order for a user to select the other device to share a data item. Ranging module 628 can also interact with a reminder module that can provide an alert based on a distance from another mobile device.

The one or more applications 634 on device 600 can include any applications installed on the device 600, including without limitation, a browser, address book, contact list, email, instant messaging, social networking, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating and displaying graphical objects (including without limitation text, web pages, icons, digital images, animations and the like) on a display surface. In another example, a timer module can be a software timer. The timer module can also be implemented in hardware. The time module can maintain various timers for any number of events.

I/O subsystem 606 can be coupled to a display system (not shown), which can be a touch-sensitive display. The display displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 606 can include a display and user input devices such as a keyboard, mouse, and/or trackpad. In some embodiments, I/O subsystem 606 can include a touch-sensitive display. A touch-sensitive display can also accept input from the user based at least part on haptic and/or tactile contact. In some embodiments, a touch-sensitive display forms a touch-sensitive surface that accepts user input. The touch-sensitive display/surface (along with any associated modules and/or sets of instructions in computer-readable medium 602) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, I/O subsystem 606 can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 600 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display, or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

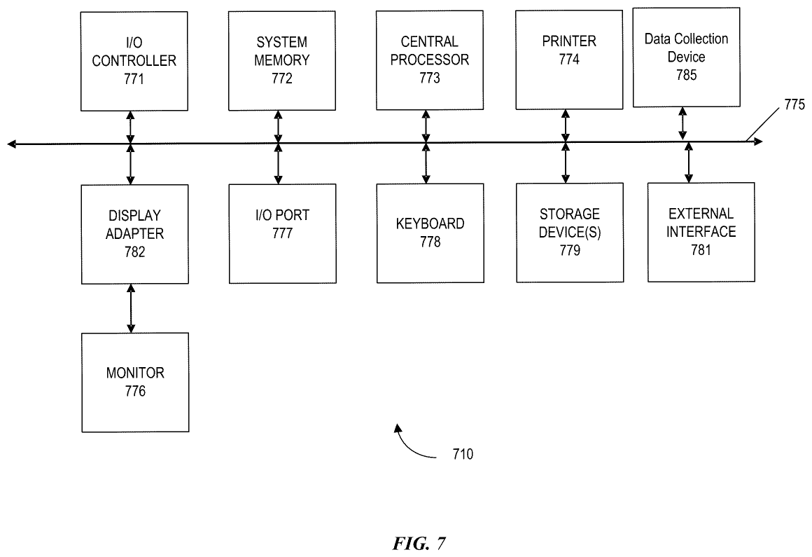

Any of the computer systems mentioned herein may utilize any suitable number of subsystems. Examples of such subsystems are shown in FIG. 7 in computer system 710. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 7 are interconnected via a system bus 775. Additional subsystems such as a printer 774, keyboard 778, storage device(s) 779, monitor 776 (e.g., a display screen, such as an LED), which is coupled to display adapter 782, and others are shown. Peripherals and input/output (I/O) devices, which couple to I/O controller 771, can be connected to the computer system by any number of means known in the art such as input/output (I/O) port 777 (e.g., USB, FireWire®). For example, I/O port 777 or external interface 781 (e.g. Ethernet, Wi-Fi, etc.) can be used to connect computer system 710 to a wide area network such as the Internet, a mouse input device, or a scanner. The interconnection via system bus 775 allows the central processor 773 to communicate with each subsystem and to control the execution of a plurality of instructions from system memory 772 or the storage device(s) 779 (e.g., a fixed disk, such as a hard drive, or optical disk), as well as the exchange of information between subsystems. The system memory 772 and/or the storage device(s) 779 may embody a computer readable medium. Another subsystem is a data collection device 785, such as a camera, microphone, accelerometer, and the like. Any of the data mentioned herein can be output from one component to another component and can be output to the user.

A computer system can include a plurality of the same components or subsystems, e.g., connected together by external interface 781, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Aspects of embodiments can be implemented in the form of control logic using hardware circuitry (e.g. an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g., a solid-state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology is the gathering, sharing, and use of data, including an authentication tag and data from which the tag is derived. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to determine a dwell spot using distance measurements that track a user through their daily routine. Further, other uses for personal information data that benefit the user are also contemplated by the present disclosure.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of sharing content and performing ranging, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Although the present disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

### III. API

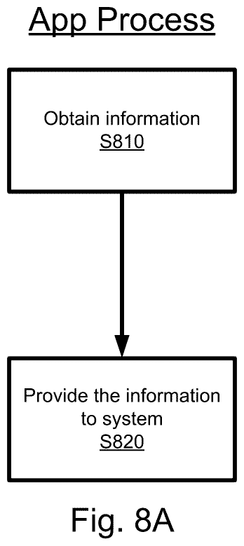

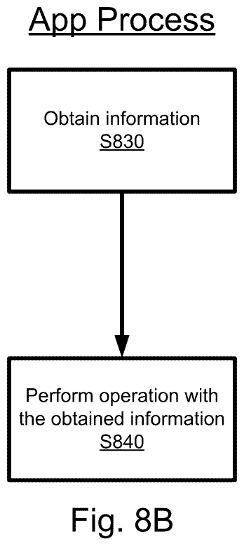

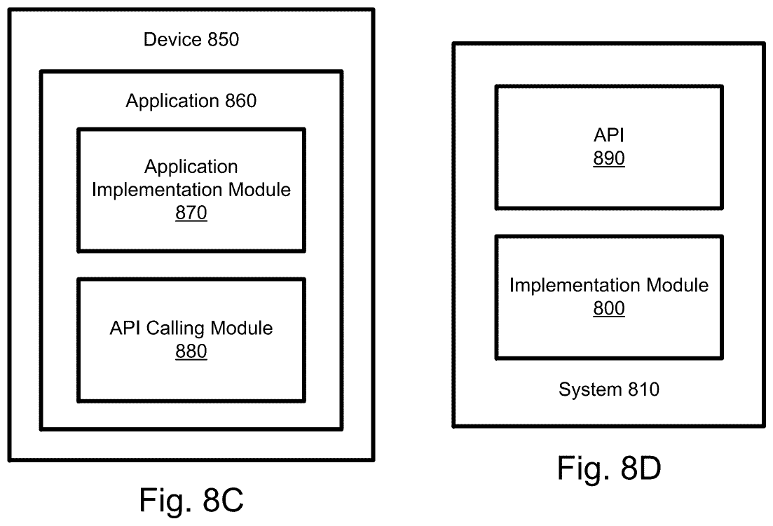

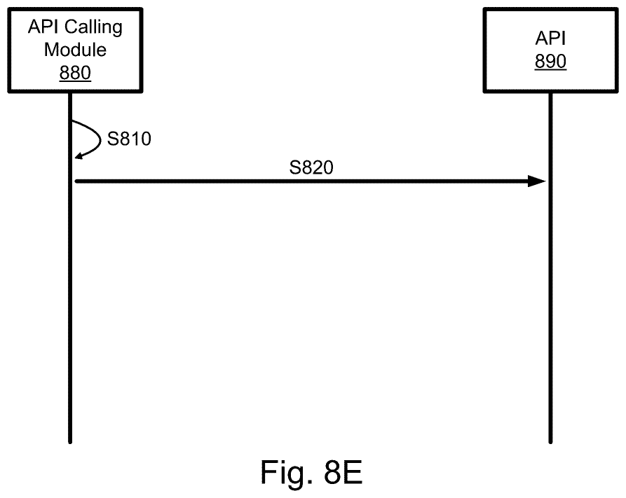

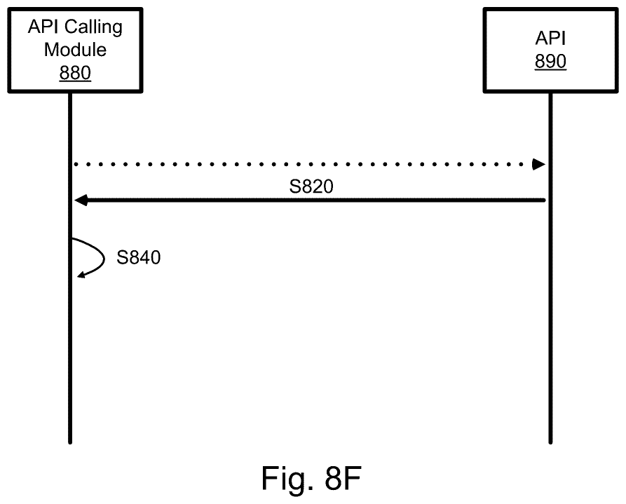

FIGS. 8A-8F show simplified diagrams of application programming interfaces for privacy protecting device communication according to at least one embodiment. Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application (e.g., application 860) that, when executed by one or more processing units, control an electronic device (e.g., device 850) to perform the method of FIG. 8A, the method of FIG. 8B, and/or one or more other processes and/or methods described herein.

It should be recognized that application 860 (shown in FIG. 8C) can be any suitable type of application, including, for example, one or more of: an accessory companion application, a browser application, an application that functions as an execution environment for plug-ins, widgets or other applications, a fitness application, a health application, a digital payments application, a media application, a social network application, a messaging application, and/or a maps application. In some embodiments, application 860 is an application that is pre-installed on device 850 at purchase (e.g., a first party application). In other embodiments, application 860 is an application that is provided to device 850 via an operating system update file (e.g., a first party application or a second party application). In other embodiments, application 860 is an application that is provided via an application store. In some embodiments, the application store can be an application store that is pre-installed on device 850 at purchase (e.g., a first party application store). In other embodiments, the application store is a third-party application store (e.g., an application store that is provided by another application store, downloaded via a network, and/or read from a storage device).

Referring to FIG. 8A and FIG. 8E, application 860 obtains information (e.g., S810). In some embodiments, at S810, information is obtained from at least one hardware component of the device 850. In some embodiments, at S810, information is obtained from at least one software module of the device 850. In some embodiments, at S810, information is obtained from at least one hardware component external to the device 850 (e.g., a peripheral device, an accessory device, a server, etc.). In some embodiments, the information obtained at S810 includes positional information, time information, notification information, user information, environment information, electronic device state information, weather information, media information, historical information, event information, hardware information, and/or motion information. In some embodiments, in response to and/or after obtaining the information at S810, application 860 provides the information to a system (e.g., S820).

In some embodiments, the system (e.g., 810 shown in FIG. 8D) is an operating system hosted on the device 850. In some embodiments, the system (e.g., 810 shown in FIG. 8E) is an external device (e.g., a server, a peripheral device, an accessory, a personal computing device, etc.) that includes an operating system.

Referring to FIG. 8B and FIG. 8F, application 860 obtains information (e.g., S830). In some embodiments, the information obtained at S830 includes positional information, time information, notification information, user information, environment information electronic device state information, weather information, media information, historical information, event information, hardware information and/or motion information. In response to and/or after obtaining the information at S830, application 860 performs an operation with the information (e.g., S840). In some embodiments, the operation performed at S840 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 810 based on the information.

In some embodiments, one or more steps of the method of FIG. 8A and/or the method of FIG. 8B is performed in response to a trigger. In some embodiments, the trigger includes detection of an event, a notification received from system 810, a user input, and/or a response to a call to an API provided by system 810.

In some embodiments, the instructions of application 860, when executed, control device 850 to perform the method of FIG. 8A and/or the method of FIG. 8B by calling an application programming interface (API) (e.g., API 890) provided by system 810. In some embodiments, application 860 performs at least a portion of the method of FIG. 8A and/or the method of FIG. 8B without calling API 890.

In some embodiments, one or more steps of the method of FIG. 8A and/or the method of FIG. 8B includes calling an API (e.g., API 890) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 8C, device 850 is illustrated. In some embodiments, device 850 is a personal computing device, a smart phone, a smart watch, a fitness tracker, a head mounted display (HMD) device, a media device, a communal device, a speaker, a television, and/or a tablet. As illustrated in FIG. 8C, device 850 includes application 860 and operating system (e.g., system 810 shown in FIG. 8F). Application 860 includes application implementation module 870 and API calling module 880. System 810 includes API 890 and implementation module 800. It should be recognized that device 850, application 860, and/or system 810 can include more, fewer, and/or different components than illustrated in FIGS. 8C and 8F.

In some embodiments, application implementation module 870 includes a set of one or more instructions corresponding to one or more operations performed by application 860. For example, when application 860 is a messaging application, application implementation module 870 can include operations to receive and send messages. In some embodiments, application implementation module 870 communicates with API calling module to communicate with system 810 via API 890 (shown in FIG. 8D).

In some embodiments, API 890 is a software module (e.g., a collection of computer-readable instructions) that provides an interface that allows a different module (e.g., API calling module 880) to access and/or use one or more functions, methods, procedures, data structures, classes, and/or other services provided by implementation module 800 of system 810. For example, API-calling module 880 can access a feature of implementation module 800 through one or more API calls or invocations (e.g., embodied by a function or a method call) exposed by API 890 and can pass data and/or control information using one or more parameters via the API calls or invocations. In some embodiments, API 890 allows application 860 to use a service provided by a Software Development Kit (SDK) library. In other embodiments, application 860 incorporates a call to a function or method provided by the SDK library and provided by API 890 or uses data types or objects defined in the SDK library and provided by API 890. In some embodiments, API-calling module 880 makes an API call via API 890 to access and use a feature of implementation module 800 that is specified by API 890. In such embodiments, implementation module 800 can return a value via API 890 to API-calling module 880 in response to the API call. The value can report to application 860 the capabilities or state of a hardware component of device 850, including those related to aspects such as input capabilities and state, output capabilities and state, processing capability, power state, storage capacity and state, and/or communications capability. In some embodiments, API 890 is implemented in part by firmware, microcode, or other low level logic that executes in part on the hardware component.

In some embodiments, API 890 allows a developer of API-calling module 880 (which can be a third-party developer) to leverage a feature provided by implementation module 800. In such embodiments, there can be one or more API-calling modules (e.g., including API-calling module 880) that communicate with implementation module 800. In some embodiments, API 890 allows multiple API-calling modules written in different programming languages to communicate with implementation module 800 (e.g., API 890 can include features for translating calls and returns between implementation module 800 and API-calling module 880) while API 890 is implemented in terms of a specific programming language. In some embodiments, API-calling module 880 calls APIs from different providers such as a set of APIs from an OS provider, another set of APIs from a plug-in provider, and/or another set of APIs from another provider (e.g., the provider of a software library) or creator of the another set of APIs.

Examples of API 890 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API. In some embodiments the sensor API is an API for accessing data associated with a sensor of device 850. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 800 is an system (e.g., operating system, server system) software module (e.g., a collection of computer-readable instructions) that is constructed to perform an operation in response to receiving an API call via API 890. In some embodiments, implementation module 800 is constructed to provide an API response (via API 890) as a result of processing an API call. By way of example, implementation module 800 and API-calling module 180 can each be any one of an operating system, a library, a device driver, an API, an application program, or other module. It should be understood that implementation module 800 and API-calling module 880 can be the same or different type of module from each other. In some embodiments, implementation module 800 is embodied at least in part in firmware, microcode, or other hardware logic.

In some embodiments, implementation module 800 returns a value through API 890 in response to an API call from API-calling module 880. While API 890 defines the syntax and result of an API call (e.g., how to invoke the API call and what the API call does), API 890 might not reveal how implementation module 800 accomplishes the function specified by the API call. Various API calls are transferred via the one or more application programming interfaces between API-calling module 880 and implementation module 800. Transferring the API calls can include issuing, initiating, invoking, calling, receiving, returning, and/or responding to the function calls or messages. In other words, transferring can describe actions by either of API-calling module 880 or implementation module 800. In some embodiments, a function call or other invocation of API 890 sends and/or receives one or more parameters through a parameter list or other structure.

In some embodiments, implementation module 800 provides more than one API, each providing a different view of or with different aspects of functionality implemented by implementation module 800. For example, one API of implementation module 800 can provide a first set of functions and can be exposed to third party developers, and another API of implementation module 800 can be hidden (e.g., not exposed) and provide a subset of the first set of functions and also provide another set of functions, such as testing or debugging functions which are not in the first set of functions. In some embodiments, implementation module 800 calls one or more other components via an underlying API and thus be both an API calling module and an implementation module. It should be recognized that implementation module 800 can include additional functions, methods, classes, data structures, and/or other features that are not specified through API 890 and are not available to API calling module 880. It should also be recognized that API calling module 880 can be on the same system as implementation module 800 or can be located remotely and access implementation module 800 using API 890 over a network. In some embodiments, implementation module 800, API 890, and/or API-calling module 880 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, method 400 (FIG. 4) is performed at a first computer system (as described herein) via a system process (e.g., an operating system process, a server system process) that is different from one or more applications executing and/or installed on the first computer system.

In some embodiments, method 400 (FIG. 4) is performed at a first computer system (as described herein) by an application that is different from a system process. In some embodiments, the instructions of the application, when executed, control the first computer system to perform method 400 (FIG. 4) by calling an application programming interface (API) provided by the system process. In some embodiments, the application performs at least a portion of method 400 without calling the API.

In some embodiments, the application is an accessory companion application that is constructed for processing communication and management between the first computer system and an accessory device (e.g., a wearable device, such as, for example, a watch).

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform method 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, the API 890 defines a first API call that can be provided by API calling module 890, wherein the definition for the first API call specifies the following call parameters: detecting a trigger event such as the launch of a. The implementation module is an system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 850) that runs the application. In some embodiments, the implementation module is included in an electronic device that is separate from the device that runs the application.

What is claimed is:

1. A method comprising:
detecting, by a system process of a mobile device, a trigger for establishing a communication pathway with an accessory device from an application that is associated with the accessory device, the trigger including an accessory identifier;
identifying, by the system process of the mobile device, a set of cryptographic information that corresponds to the accessory device based on a mapping of accessory identifiers to sets of cryptographic information;
accessing, by the system process of the mobile device, an advertising message that corresponds to the set of cryptographic information;
establishing, by the system process of the mobile device, the communication pathway between the mobile device and the accessory device using information that is associated with the advertising message; and
permitting, by the system process of the mobile device, communication between the application and the accessory device via the communication pathway.

2. The method of claim 1, wherein detecting the trigger comprises:
receiving, by the system process of the mobile device, a request for the communication pathway with the accessory device, the request received as input to the application that is associated with the accessory device; and
designating, by the system process of the mobile device, the request as the trigger.

3. The method of claim 1, wherein detecting the trigger comprises:
detecting, by the system process of the mobile device, a launch of the application that is associated with the accessory device; and
designating, by the system process of the mobile device, the launch of the application as the trigger.

4. The method of claim 1, wherein detecting the trigger comprises:
detecting, by the system process of the mobile device, a scheduled operation of the application that is associated with the accessory device; and
designating, by the system process of the mobile device, the scheduled operation of the application as the trigger.

5. The method of claim 4, wherein the scheduled operation is an operation to update a software of the accessory device.

6. The method of claim 1, wherein the application is associated with the accessory device if the accessory device has performed a pairing process comprising:
providing, by the accessory device and to the system process of the mobile device, the accessory identifier for the accessory device; and
adding, by the system process of the mobile device, the accessory identifier to the mapping of accessory identifiers to the sets of cryptographic information.

7. The method of claim 1, wherein the application is not permitted to access the mapping of accessory identifiers to sets of cryptographic information.

8. The method of claim 1, wherein the application is a third-party application with respect to the mobile device.

9. The method of claim 1, wherein the accessory identifier assigned to the accessory device during a manufacturing process.

10. The method of claim 9, wherein the accessory identifier is a hardware identifier or serial number of the accessory device.

11. The method of claim 1, wherein the information associated with the advertising message comprises a communication window and a communication time period for receiving a request to establish the communication pathway between the application and the accessory device.

12. The method of claim 1, wherein the cryptographic information includes one or more of a key derivation function, a protocol identifier, and a derived accessory identifier.

13. A computing device, comprising:
one or more memories; and
one or more processors in communication with the one or more memories and configured to execute instructions stored in the one or more memories to perform operations comprising:
detecting, by a system process of the computing device, a trigger for establishing a communication pathway with an accessory device from an application that is associated with the accessory device, the trigger including an accessory identifier;
identifying, by the system process of the computing device, a set of cryptographic information that corresponds to the accessory device based on a mapping of accessory identifiers to sets of cryptographic information;
accessing, by the system process of the computing device, an advertising message that corresponds to the set of cryptographic information;
establishing, by the system process of the computing device, the communication pathway between the mobile device and the accessory device using information that is associated with the advertising message; and
permitting, by the system process of the computing device, communication between the application and the accessory device via the communication pathway.

14. The computing device of claim 13, wherein detecting the trigger comprises:
receiving, by the system process of the computing device, a request for the communication pathway with the accessory device, the request received as input to the application that is associated with the accessory device; and
designating, by the system process of the computing device, the request as the trigger.

15. The computing device of claim 13, wherein detecting the trigger comprises:
detecting, by the system process of the computing device, a launch of the application that is associated with the accessory device; and
designating, by the system process of the computing device, the launch of the application as the trigger.

16. The computing device of claim 13, wherein detecting the trigger comprises:
detecting, by the system process of the computing device, a scheduled operation of the application that is associated with the accessory device; and
designating, by the system process of the computing device, the scheduled operation of the application as the trigger.

17. A non-transitory computer-readable medium storing a plurality of instructions that, when executed by one or more processors of a computing device, cause the one or more processors to perform operations comprising:
detecting, by a system process of the computing device, a trigger for establishing a communication pathway with an accessory device from an application that is associated with the accessory device, the trigger including an accessory identifier;
identifying, by the system process of the computing device, a set of cryptographic information that corresponds to the accessory device based on a mapping of accessory identifiers to sets of cryptographic information;
accessing, by the system process of the computing device, an advertising message that corresponds to the set of cryptographic information;
establishing, by the system process of the computing device, the communication pathway between the mobile device and the accessory device using information that is associated with the advertising message; and
permitting, by the system process of the computing device, communication between the application and the accessory device via the communication pathway.

18. The non-transitory computer-readable medium of claim 17, wherein the application is associated with the accessory device if the accessory device has performed a pairing process comprising:
providing, by the accessory device and to the system process of the computing device, the accessory identifier for the accessory device; and
adding, by the system process of the computing device, the accessory identifier to the mapping of accessory identifiers to the sets of cryptographic information.

19. The non-transitory computer-readable medium of claim 17, wherein the application is not permitted to access the mapping of accessory identifiers to sets of cryptographic information.

20. The non-transitory computer-readable medium of claim 17, wherein the application is a third-party application with respect to the computing device.
